(19) United States
(12) Patent Application Publication
(10) Pub. No.: US 2009/0285952 A1
(43) Pub. Date: Nov. 19, 2009

(54) Transparent Emulsified Composition for Use in Beverages

(76) Inventors: Kaneaki Sekikawa, Tokyo (JP); Michiteru Watanabe, Tokyo (JP)

Correspondence Address: CURATOLO SIDOTI CO., LPA, 24500 CENTER RIDGE ROAD, SUITE 280, CLEVELAND, OH, 44145, US

(21) Appl. No.: 12/447,976

(22) PCT Filed: Nov. 7, 2007
(86) PCT No.: PCT/CH07/00549

§ 371 Date: May 1, 2009

(30) Foreign Application Priority Data
Nov. 8, 2006 (JP) 2006-302961

(51) Int. Cl. C12H 1/14; A23J 7/00; A23D 9/013; A23L 1/23

(52) U.S. Cl. 426/330.4; 426/662; 426/610; 426/592; 426/651

(57) ABSTRACT

A transparent emulsified composition and transparent emulsified flavor composition containing enzyme-degraded lecithin, for use in alcoholic drinks or carbonated drinks. The compositions exhibit emulsification stability and transparency, and they can maintain flavor of alcoholic drink products or carbonated drink products.

### CROSS REFERENCE TO RELATED APPLICATIONS

This application is a national stage application of International Application No. PCT/CH2007/000549, filed 7 Nov. 2007, which claims the benefit of Patent Application Serial No. JP 2006-302961, filed 8 Nov. 2006 from which applications priority is claimed, and which are incorporated herein by reference.

This invention relates to a transparent emulsified composition and a flavor composition using said transparent composition, for use in alcoholic drinks or carbonated drinks.

In many drink products, it is important to maintain the flavor of the products, while at the same time providing and maintaining emulsification stability and transparency, that is, preventing the precipitation of insoluble solids and infusible components. One way of achieving this object is to use emulsifier compositions, typically polyglycerin fatty acid esters, sucrose fatty acid esters, water-insoluble materials such as oils, water and polyvalent alcohols. Specific examples known to the art include the following:

Japanese patent application 2001-25654 describes a composition containing a sucrose fatty acid diester used as the surface-active auxiliary having high efficiency in increasing the capacity of solubilization, when microemulsions are produced using a polyglycerin fatty acid ester.

Japanese published patent application 2004-208555 describes an emulsifier formulation which disperses oily materials into water in a stable manner, these containing an oily material, a polyvalent alcohol, and an emulsifier (sucrose fatty acid ester, polyoxyethylene derivative, lecithin derivative).

Japanese published patent application 2000-152763 describes an aqueous flavor composition which can be used in transparent drinks without deteriorating the products' flavor, and without a problem of foaming. Flavor compositions containing a sucrose fatty acid ester are also disclosed.

Japanese published patent application 2000-212066 describes a stable aqueous liquid formulation of lipophilic materials containing a lipophilic material (such as a drug, vitamin, fat or oil), an emulsifier (polyglycerin fatty acid (stearic acid) ester, lysolecithin), and a polyvalent alcohol. The formulation has superior transparency and flavor, and which can maintain homogeneity for a long period.

Also known are the following:

A transparent drink containing a sucrose fatty acid ester and a polyglycerin fatty acid ester (Japanese published patent application 2000-333654);
An emulsifier composition with improved solubility containing a sucrose fatty acid ester, a polyglycerin fatty acid ester, a polyvalent alcohol and water (Japanese published patent application 2001-128653);
A dispersing composition with improved storage stability which containing a sucrose fatty acid ester, enzyme-degraded lecithin and a polyglycerin fatty acid ester (Japanese published patent application 2000-300225).

Japanese published patent application 2000-245385 describes a flavor composition containing sucrose palmitic acid ester, lysolecithin, decaglycerin stearic acid monoester, purified glycerin and ion-exchanged water as a flavor composition used for the production of transparent drinks, such as uncarbonated drinks, without the occurrence of precipitation or turbidity, this being characterized in that said flavor composition contains a flavor such as peach or orange flavor, a sucrose fatty acid ester with an HLB from 16 to 19, preferably sucrose palmitic acid monoester, and lysolecithin. Compositions containing a lecithin derivative are also described in several of the abovementioned documents.

However, when any of the compositions or flavor compositions described in these documents were used in the preparation of alcoholic drinks or carbonated drinks, emulsification stability, transparency or flavor were not sufficiently maintained, giving unsatisfactory results.

One way of achieving satisfactory results is to use an organic monoglyceride. Japanese published patent application 2003-24510 describes a composition having alcohol resistance in which an organic monoglyceride is added as the emulsifier. This allows the maintenance of a stable, soluble, emulsified and dissolved condition in alcoholic drinks. It also exhibits the superior alcohol resistance, acid resistance and salt resistance required for addition to such drinks. However, because organic monoglycerides have adverse effects on flavors of products, this composition is not completely satisfactory.

Accordingly, there still exists a need for transparent emulsified compositions which can be used in alcoholic drink products or carbonated drink products, and which can provide emulsification stability and transparency in these products without deteriorating the flavor of the products.

It has now been found that, by blending enzyme-degraded lecithin as an additional component into a transparent emulsified composition or a transparent emulsified flavor composition for use in alcoholic drinks or carbonated drinks, it is possible to produce a transparent emulsified composition (microemulsion) with both high emulsification stability and high retention of flavor level, something not previously possible.

The invention therefore provides a transparent emulsified composition comprising enzyme-degraded lecithin for use in alcoholic drinks or carbonated drinks.

The invention also relates to the abovementioned composition wherein the enzyme-degraded lecithin is lysolecithin.

Furthermore, the invention relates to the abovementioned composition further comprising lecithin, wherein the ratio of the content of enzyme-degraded lecithin to lecithin is from 2.5:7.5 to 4.5:5.5.

Moreover, the invention relates to the abovementioned composition which further comprises at least one material selected from (B) polyglycerin fatty acid ester, (C) sucrose fatty acid ester, (D) polyvalent alcohol and (E) water.

Furthermore, the invention relates to the abovementioned composition, wherein (B) polyglycerin fatty acid ester is a monoester of decaglycerin and a fatty acid having from 14-16 carbon atoms.

Moreover, the invention relates to the abovementioned composition wherein the fatty acid having from 14-16 carbon atoms is a monoester of myristic acid and/or palmitic acid.

Furthermore, the invention relates to the abovementioned composition wherein (C) sucrose fatty acid ester is a monoester of sucrose and a fatty acid with from 14-18 carbon atoms.

Moreover, the invention relates to the abovementioned composition wherein the fatty acid with from 14-18 carbon atoms is selected from myristic acid, palmitic acid and stearic acid.

Moreover, the invention relates to the abovementioned composition wherein (D) polyvalent alcohol is at least one materials from propylene glycol and glycerin.

Furthermore, the invention relates to the abovementioned composition, comprising

0.1-2 wt % of (A) enzyme-degraded lecithin,
3-10 wt % of (B) polyglycerin fatty acid ester,
1-5 wt % of (C) sucrose fatty acid ester,
50-85 wt % of (D) polyvalent alcohol, and
1-10 wt % of (E) water.

Furthermore, the invention relates to a flavor composition comprising any one of the abovementioned compositions and a flavor, for use in alcoholic drinks or carbonated drinks.

Moreover, the invention relates to an alcoholic drink or carbonated drink containing the abovementioned flavor composition.

Furthermore, the invention relates to a method of maintaining flavor in alcoholic drinks or carbonated drinks, by means of adding the abovementioned flavor composition.

The invention also relates to a method for the preparation of a transparent emulsified composition comprising (A) enzyme-degraded lecithin, (B) polyglycerin fatty acid ester, (C) sucrose fatty acid ester, (D) polyvalent alcohol, and (E) water for use in alcoholic drinks or carbonated drinks, comprising:

blending the components (B), (C), (D) and (E) together, and
dissolving (A) enzyme-degraded lecithin in the blended components.

The blending of (B), (C), (D) and (E) may be done in any convenient order or combination. For example, (B) may be blended (C)+(D), with (E) then being added, or (C) may be blended with (D)+(E), with (B) then being added. However, all of (B)−(E) are blended together prior to the addition of (A)

In this description, the following terms have the given meanings:

“Transparency”—visual absence of turbidity caused by insolubility or poorly-soluble materials;
“Alcoholic drinks or carbonated drinks”—includes carbonated alcoholic drinks;
“Transparent emulsified composition”—a composition which, when being blended with a flavour provides sufficient transparency and flavor in drinks to which the composition is added, by means of formation of an emulsion;
“Transparent emulsified flavour composition” or “flavour composition”—a composition made by blending a flavour with a “transparent emulsified composition.”

As mentioned hereinabove, the transparent emulsified compositions of the invention are characterized by being microemulsions, something usually not found in alcoholic drinks and carbonated drinks. This is believed to be a result of the presence of enzyme-degraded lecithin, which apparently helps maintain flavors when a flavoring component such as a flavor containing a refined oil is added, in addition to maintaining emulsification stability and transparency in alcoholic drinks or carbonated drinks. With the transparent emulsified composition of the invention, emulsification stability, transparency (alcohol resistance, acid resistance, salt resistance and heat resistance) and flavor (in the sense of both better aroma and taste) of alcoholic drinks or carbonated drinks can be maintained.

Particularly favoured compositions are those in which, independently.

i) the (A) enzyme-degraded lecithin is lysolecithin;
ii) the content of enzyme-degraded lecithin to lecithin is from 2.5:7.5 to 4.5:5.5

Other improvements in emulsion stability, transparency and flavor can be obtained by the use of least one of (B) polyglycerin fatty acid ester, (C) sucrose fatty acid ester, (D) polyvalent alcohol and (E) water. The polyglycerin fatty acid ester is particularly a monoester of decaglycerin and a fatty acid with 14-16 carbon atoms, more particularly wherein the fatty acid is a monoester of myristic acid and/or palmitic acid. The (C) sucrose fatty acid ester is particularly a monoester of sucrose and a fatty acid with 14-18 carbon atoms, in particular, wherein the fatty acid at least one of myristic acid, palmitic acid and stearic acid. The (D) polyvalent alcohol is particularly selected from propylene glycol and glycerin.

Particular compositions are those containing 0.1-2 wt % of (A) enzyme-degraded lecithin, 3-10 wt % of (B) polyglycerin fatty acid ester, 1-5 wt % of (C) sucrose fatty acid ester, 50-93.9 wt % of (D) polyvalent alcohol, and 1-10 wt % of (E) water.

With the flavour composition for alcoholic drinks or carbonated drinks containing any one of the compositions described above and a flavour, emulsification stability, transparency and flavor of alcoholic drinks or carbonated drinks can be effectively maintained and adjusted.

When lecithin is also present, the ratio of enzyme-degraded lecithin to lecithin is, but not limited to, for example, from 1:9 to 9:1, preferably from 2:8 to 8:2, and more preferably from 2.5:7.5 to 7.5:2.5, and furthermore preferably from 2.5:7.5 to 4.5:5.5. Within the range of these ratios, transparency in alcoholic drinks or carbonated drinks to which the composition of the invention is added is sufficiently maintained, and their flavor is maintained particularly well.

The proportion of enzyme-degraded lecithin in the composition of the invention is not limited to specific values, but considering the above-described action of the enzyme-degraded lecithin. The proportion of the enzyme-degraded lecithin in the composition is typically 0.10-15 wt %, preferably 0.50-12 wt %, and more preferably 1.05-10 wt %, although higher or lower proportions may also be used In addition, the use of enzyme-degraded lecithin allows the use of larger proportions of conventional materials, such as sucrose fatty acid ester and polyglycerin fatty acid ester.

Within the abovementioned ranges, sufficient emulsification effects of the enzyme-degraded lecithin can be obtained, and flavor can be sufficiently maintained. The proportion of enzyme-degraded lecithin used in the flavor composition for alcoholic drinks or carbonated drinks of the invention is preferably from 0.083-15 wt %, more preferably 0.42-12 wt %, and most preferably 1.01-10 wt % relative to the total amount of the flavor composition. In all cases, the proportion of enzyme-degraded lecithin relative to that of sucrose fatty acid ester is, but not limited to, for example, 0.1-5 parts by weight, preferably 0.5-3 parts by weight, and more preferably 1-3 parts by weight relative to 1 part by weight of the sucrose fatty acid ester.

(B) Polyglycerin fatty acid ester used in the invention is at least one fatty acid ester of polyglycerin, which are suitable for use in drinks. Examples include polyglycerin fatty acid esters consisting of mono- or diester of glycerin with an average degree of polymerization of 5-15, preferably 6-12, and most preferably decaglycerin. Examples of the fatty acid moiety include a fatty acid with from 8-22 carbon atoms, preferably a fatty acid with from 14-18 carbon atoms, and more preferably a fatty acid with from 4-16 carbon atoms. Accordingly, preferred polyglycerin fatty acid esters include a monoester of decaglycerin and miristic acid or palmitic acid. In addition, those wherein the ratio of the amount of the monoester of decaglycerin and miristic acid or palmitic acid relative to the entire polyglycerin fatty acid ester is 90% or more are also preferable.

The proportion of the polyglycerin fatty acid ester in the composition of the invention is typically, but is not limited to, 0.1-50 wt %, preferably 1-30 wt %, and more preferably 3-10 wt %. When the proportion of the polyglycerin fatty acid ester is 1 wt % or more, the composition shows superior emulsification stability, and when the amount is 50 wt % or less, flavor of the alcoholic drinks or carbonated drinks to which this composition has been added can be well maintained.

(C) Sucrose fatty acid ester used in the invention is at least one ester of sucrose and a fatty acid ester. The fatty acid preferably has from 8-22, more preferably from 10-20, and most from 14-18 carbon atoms.

The esters of sucrose and a fatty acid with from 4-18 carbon atoms are preferred; in particular, a monoester of a fatty acid selected from myristric acid, palmitic acid and stearic acid is preferred. Those wherein the ratio of the amount of the monoester of a fatty acid selected from myristric acid, palmitic acid and stearic acid relative to the amount of the entire sucrose fatty acid ester is 90% or more are also preferred. The proportion of the sucrose fatty acid ester in the composition of the invention is typically, but is not limited to, 0.1-15 wt %, preferably 1-10 wt %, and more preferably 1.5-5 wt %. When the proportion of the sucrose fatty acid ester is 0.1 wt % or more, higher emulsification stability can be obtained, and when the amount is 15 wt % or less, physical properties such as viscosity are good.

(D) Polyvalent alcohol used in the invention is at least one alcohol having at least 2 hydroxyl groups in one molecule, suitable for use in drinks. Examples include glycols such as glycerin, propylene glycol and butylene glycol, and sugar alcohols such as maltitol, erythritol, sorbitol and mannitol. Glycerin and glycols are preferred, and glycerin and propylene glycol are particularly preferred, those using both glycerin and propylene glycol being particularly preferred.

In a composition according to the invention, it is possible to use a larger proportion of polyvalent alcohol than would be possible in conventional compositions, and such compositions are preferred. Accordingly, the proportion of polyvalent alcohol in the composition of the invention is 30-97 wt %, preferably 45-93 wt %, and more preferably 50-85 wt %. When the proportion of the polyvalent alcohol is 30-97 wt %, the proportions of emulsifiers and water-insoluble components may be reduced, and a composition with good emulsification stability and flavor can be obtained.

(E) Water for use in the invention may be any water suitable for use in drinks. It may be pure, or it may have food additives incorporated therein.

The proportion of water is typically, but is not limited to, 0.1-50 wt %, preferably 0.5-30 wt %, and more preferably 1-10 wt %. When the proportion of water is 50 wt % or less, the proportion of water-insoluble components may be reduced, and the composition which can sufficiently maintain emulsification stability and flavor of products can be obtained.

Particularly preferred compositions of the invention are those containing the following:

3-10 wt % of (B) polyglycerin fatty acid ester,
1-5 wt % of (C) sucrose fatty acid ester,
0.1-2 wt % of (A) enzyme-degraded lecithin,
50-85 wt % of (D) polyvalent alcohol,
1-10 wt % of (E) water,

In the compositions of the invention, in addition to the abovementioned components, there can be added other standard ingredients in art-recognised quantities, known to be useful for specific purposes. Such ingredients include, but are not limited to, antioxidants, preservatives and emulsifiers. As the antioxidant, both water-soluble antioxidants and lipid-soluble antioxidants may be used, and vitamin C and vitamin E are preferable antioxidants.

The method for the preparation of compositions of the invention includes, but is not limited to, methods comprising

dissolving (B) polyglycerin fatty acid ester in (D) polyvalent alcohol and/or (E) water,
dissolving (C) sucrose fatty acid ester in (D) polyvalent alcohol and/or (E) water, and
dissolving (A) enzyme-degraded lecithin,
which are more effective and preferable.

The method may be performed using standard equipment known to and used by the art. Examples include homogenizers, colloid mills, microfluidizers, ultimizers and nanomizers. Specific examples of homogenizers include high-pressure homogenizers, ultrasound emulsifying machines, and homomixers such as TK homomixer, Adihomomixer, Ultramixer and Clearmix.

The flavor used in conjunction with this invention may be a flavor oil. Such oils are generally, but not always, volatile oils generally found in plants. Examples include lemon oil, orange oil, citrus oil, menthol, yuzu (citrus junos) oil, perilla oil, refined oils derived from natural lemon, orange, yuzu or perilla, and middle-chain fatty acids (triesters of glycerin and middle-chain fatty acids). In addition, oil-soluble preparations without an oily characteristic obtained from plant oils, for example extracted vitamin E, can be used as the refined oil of the invention. In particular, orange oil, citrus oil, middle-chain fatty acids and oil-soluble antioxidants are preferred.

The middle-chain fatty acids may be synthetic materials; for example, an ester of glycerin and a fatty acid with from 6-12, more particularly from 8-10, carbon atoms, and in particular triesters of glycerin and capric acid or caprylic acid.

As the flavor, there may be used fruit-type flavors such as plum, ume (Japanese apricot), grape, apple, pear, strawberry, orange, lemon, grapefruit, and lime; refreshing-drink-type flavors such as cider and coke; and luxury-item-type flavors such as coffee, tea, green tea and oolong tea.

The proportion of the flavor such as a refined oil in the flavor composition for alcoholic drinks or carbonated drinks may be, but is not limited to, 0.1-20 wt %, preferably 1-10 wt %, and more preferably 2-8 wt %, relative to the total weight of the flavor composition.

The method for the preparation of the flavor composition of the invention may be, but is not limited to, for example, a method wherein a refined oil or flavor is added to the above composition in the form of aqueous solution.

By adding the flavor composition of the invention to alcoholic drinks or carbonated drinks, products with particularly stable transparency and flavor can be made. Such drinks include alcoholic drinks (such as shochu-based beverage containing carbon dioxide, beer, sparkling wine, gin and tonic and others, sake or sake-based drinks), and/or carbonated drinks (such as ciders, cola drinks, sports drink, vitamin drink, mineral drink, health drink, fruit drink and lactic acid bacteria drink).

The method for the preparation of such drink products may be, but is not limited to, a method wherein the flavor composition of the invention is added and mixed to a liquid mixture of purified water and fruit juices.

The proportion of flavor composition of the invention is, but not limited to, typically 0.001-2 wt %, preferably 0.01-1 wt %, and more preferably 0.02-0.5% relative to the total weight of the product.

In the invention, when a refined oil is used as the flavor, oils other than the refined oil may be added as a component of the refined oil, or as an independent component. The “oil” in the specification of the invention refers to a material insoluble or slightly soluble in water. Examples include at least one material selected from fats and oils, oil-soluble vitamins and lipids, which are used in food and drink.

The fats and oils refer to those derived from animal, plant and microorganism sources; compressed and unrefined/refined products of these fats and oils, as well as hydrogen-added fats and oils are also included in the fats and oils of the invention.

When the lipophilicity of the flavor added is not sufficient, the emulsification stability of the flavor can be increased by the addition of an oil to the composition of the invention, so that a microemulsion with more superior transparency can be obtained.

Concrete examples of the oil include the following:

as fats and oils, lard, beef tallow, chicken oil, whale oil, tuna oil, sardine oil, mackerel oil, saury oil, bonito oil, herring oil, cod-liver oil, soybean oil, cottonseed oil, safflower oil, rice-bran oil, corn oil, rapeseed oil, palm oil, Japanese basil oil, perilla oil, cocoa butter, peanut oil, coconut oil, evening-primrose oil, borage oil, jojoba oil and others.

Other examples include squalene, squalane, lanolin, fluid paraffin, glycosyl ceramide, octacosanol, phytosterol, lycopene, beta-carotene, lutein, minerals and others.

The proportion of the oil used in the invention may be, but is not limited to, 0.1-20 wt %, preferably 0.5-15 wt %, and more preferably 1-10 wt %.

The invention is explained in further detail with reference to the following non-limiting examples, which describe preferred embodiments.

### EXAMPLE 1

5 g of polyglycerin fatty acid ester (brand name: M-7D, Mitsubishi Kagaku Foods Corporation) were dissolved in an aqueous glycerin solution (glycerin 76.1 g, water 2.3 g) (aqueous solution A). 2 g of sucrose fatty acid ester (brand name: DK ester SS, Dai-ichi Kogyo Seiyaku Co., Ltd.) were dissolved by warming in an aqueous propylene glycol solution (propylene glycol 4.5 g, water 2.1 g) (aqueous solution B). Then the solutions A and B were mixed by warming.

### EXAMPLE 2

To the mixture obtained in Example 1, a mixture of 5 g of an orange oil containing 1 g of a glycerin middle-chain fatty acid ester and 1 g of enzyme-degraded lecithin (brand name: Emultop, Degussa Japan) was gradually mixed and agitated, then homogenized using a high-pressure homogenizer.

0.1 g of the above aqueous flavor composition was dissolved in 100 g of an aqueous solution containing 8.8 g of fructose-glucose liquid sugar and 0.07 g of citric acid, giving the transparent drink.

### COMPARATIVE EXAMPLE 1

A composition was prepared in accordance with the invention described in Japanese patent application 2003-284510.

10 g of polyglycerin fatty acid (brand name: Sunsoft Q-17S, Taiyo Kagaku Co., Ltd.), 5 g of a mixed emulsifier (brand name: SEM-70, Mitsubishi Kagaku Foods Corporation) of sucrose fatty acid ester with organic acid monoglyceride, 20 g of water, and 60 g of glucose-fructose liquid sugar (brand name: Newcraft F0, Showa Sangyo Co., Ltd.) were dissolved by warming. 5 g of an orange oil were gradually mixed and agitated into this solution, and the solution was homogenized using a high-pressure homogenizer.

### COMPARATIVE EXAMPLE 2

0.1 g of the aqueous flavor composition obtained in Comparative example 1 was dissolved in 100 g of an aqueous solution containing 8.8 g of fructose-glucose liquid sugar and 0.07 g of citric acid, giving the drink.

### TEST EXAMPLE

### Comparison of the Flavor Between Drinks Containing Emulsified Flavors

### (1) Material

The drinks obtained in the above Example 2 and Comparative example 2 were subjected to a sensory evaluation test.

### (2) Method

By means of a 2-object evaluation method by 8 members of company's expert panel, the composition having bitter taste and/or rough texture was selected.

### (3) Result

As shown in Table 1, the drink containing the flavor composition of Example 2 showed better flavor and texture compared to the drink containing the flavor composition of Comparative example 2.

Therefore, the flavor composition of the invention has superior flavor maintenance, compared to the conventional composition.

TABLE 1

| | The number of members |
|---|---|
| | who felt bitter taste |
| | and/or rough texture |
| Drink containing flavor composition of | 2 |
| Example 2 | |
| Drink containing flavor composition of | 6 |
| Comparative example 2 | |

### EXAMPLE 3

5 g of polyglycerin fatty acid ester (brand name: M-7D, Mitsubishi Kagaku Foods Corporation) were dissolved in an aqueous glycerin solution (glycerin 76.1 g, water 2.3 g) (aqueous solution C). 2 g of sucrose fatty acid ester (brand name: DK ester SS, Dai-ichi Kogyo Seiyaku Co., Ltd.), 0.050 g of vitamin C and 0.05 g of fitic acid were dissolved by warming in an aqueous propylene glycol solution (propylene glycol 4.5 g, water 2.1 g) (aqueous solution D). Then the solutions C and D were mixed by warming.

### EXAMPLE 4

To the mixture obtained in Example 3, 5 g of a lemon oil containing 1 g of a glycerin middle-chain fatty acid ester, 0.002 g of Riken E oil 800 and 1 g of enzyme-degraded lecithin (brand name: Emultop, Degussa Japan) were gradually mixed and agitated, then homogenized using a high-pressure homogenizer, giving the transparent emulsified flavor composition.

### TEST EXAMPLE 2

### Alcohol Resistance Test

(1) Material Using the flavor composition obtained in Example 4, the following test solution was prepared and used for the test.

The transparent emulsified flavor composition of Example 4 was added at a ratio of 0.4% to the 28% alcoholic solution shown below.

TABLE 2

| Material name | Amount of blending | |
|---|---|---|
| 95% ethanol | 29.48 | ml |
| Fructose-glucose liquid sugar 75° | 28 | g |
| Anhydrous citric acid | 1 | g |
| Citric acid Na | 0.12 | g |
| Blending water | 41.4 | g |
| Total | 100 | ml |

Solutions with an alcohol content of 22-50% were prepared by changing the amounts of 95% ethanol and blending water.

### (2) Method

Evaluation was performed by visual confirmation and UV transmission (550 nm).

### (3) Result

As shown in Table 3, the flavor composition of Example 4 showed superior alcohol resistance.

TABLE 3

| Storage | | Alcohol content (wt %) | | | |
|---|---|---|---|---|---|
| condition | Evaluation method | 22% | 28% | 40% | 50% |
| 55° C. 72 hr | Visual confirmation | ∘ | ∘ | x | x |
| | UV transmission (550 nm) | 99.9 | 100 | 93.3 | 93.5 |
| 35° C. 72 hr | Visual confirmation | ∘ | ∘ | x | x |
| | UV transmission (550 nm) | 99.7 | 99.7 | 96.8 | 95.5 |
| 20° C. 72 hr | Visual confirmation | ∘ | ∘ | ∘ | x |
| | UV transmission (550 nm) | 99.5 | 99.6 | 99.5 | 95.1 |
| −5° C. 72 hr | Visual confirmation | ∘ | ∘ | ∘ | x |
| | UV transmission (550 nm) | 99.9 | 99.3 | 99.7 | 97.8 |

∘Transparent
x Turbid

### TEST EXAMPLE 3

### Acid Resistance and Salt Resistance Test

### (1) Material

The transparent emulsified flavor composition obtained in Example 4 was added at a ratio of 0.4%, and pH and salt level were adjusted.

pH was adjusted using citric acid and citric acid Na. Salt level was adjusted using NaCl. In addition, in the case of both pH and salt level, they were adjusted using both of the above two reagents.

### (2) Method

Evaluation was performed by measuring average particle sizes using a particle size distribution meter

### (3) Result

As shown in Table 4, the flavor composition of Example 4 showed good acid resistance and salt resistance.

TABLE 4

| | | Left at room | | |
|---|---|---|---|---|
| | | temperature | Heating* | Evalu- |
| Item | Item | [nm] | [nm] | ation |
| Acid resistance | 1)pH 2.21 | 51.7 | 85.9 | x |
| | 2)pH 3.1 | 44.3 | 51.4 | ∘ |
| | 3)pH 4.4 | 50.4 | 49.1 | ∘ |
| Salt resistance | 4)0.1% | 52.0 | 45.1 | ∘ |
| | 5)0.5% | 42.2 | 46.9 | ∘ |
| | 6)1% | 43.1 | 52.8 | ∘ |
| Acid resistance, | 1)pH 3-NaCl1.0% | 55.1 | 151.4 | x |
| salt | 2)pH 3-NaCl0.5% | 59.3 | 67.4 | ∘ |
| resistance, heat | 3)pH 4-NaCl1.0% | 54.9 | 59.9 | ∘ |
| resistance | | | | |

*After being heated at 85° C. for 30 min, left at room temperature for 1 day.
∘ Transparent
x Turbid

### TEST EXAMPLE 4

### Difference in the Flavor Between Carbonated Alcoholic Drinks

### (1) Preparation of Sensory Evaluation Test Solutions

An aqueous solution was prepared in accordance with Table 2 using the transparent emulsified flavor composition obtained in Example 4 and then the resulting solution was diluted 4 times with carbonated water to give the carbonated alcoholic drink used for sensory evaluation test (Example 5). As a comparative example, the orange oil in Comparative example 1 was replaced with a lemon oil to prepare the transparent emulsified flavor composition, an aqueous solution was prepared in accordance with Table 2 as described above and diluted 4 times with carbonated water to give the control carbonated alcoholic drink (Comparative example 3).

### (2) Result

While the carbonated alcoholic drink prepared with the composition of the example (Example 5) had a refreshing flavor, the carbonated alcoholic drink prepared with the composition of the comparative example (Comparative example 3) was oily and bitter in taste.

1. A transparent emulsified composition containing enzyme-degraded lecithin for use in alcoholic drinks or carbonated drinks.

2. The composition according to claim 1, wherein the enzyme-degraded lecithin is lysolecithin.

3. The composition according to claim 1, in which the composition contains lecithin, in a ratio of enzyme-degraded lecithin to lecithin from 2.5:7.5 to 4.5:5.5.

4. The composition according to claim 1, further containing one or more materials from (B) polyglycerin fatty acid ester, (C) sucrose fatty acid ester, (D) polyvalent alcohol and (E) water.

5. The composition according to claim 4, wherein the polyglycerin fatty acid ester is a monoester of decaglycerin and a fatty acid with from 14-16 carbon atoms.

6. The composition according to claim 5, wherein the fatty acid is a monoester of myristic acid and/or palmitic acid.

7. The composition according to claim 4, wherein the sucrose fatty acid ester is a monoester of sucrose and a fatty acid with from 14-18 carbon atoms.

8. The composition according to claim 7, wherein the fatty acid is selected from myristic acid, palmitic acid and stearic acid.

9. The composition according to claim 4, wherein the polyvalent alcohol is one or more materials from propylene glycol and glycerin.

10. The composition according to claim 4, containing
0.1-2 wt % of (A) enzyme-degraded lecithin,
3-10 wt % of (B) polyglycerin fatty acid ester,
1-5 wt % of (C) sucrose fatty acid ester,
50-85 wt % of (D) polyvalent alcohol, and
1-10 wt % of (E) water.

11. A flavor composition containing the composition according to claim 1 and a flavor, for use in alcoholic drinks or carbonated drinks.

12. An alcoholic drink or carbonated drink containing the flavor composition according to claim 11.

13. A method of maintaining flavors in alcoholic drinks or carbonated drinks, comprising the addition to the drink of flavor composition according to claim 11.

14. A method for the preparation of a transparent emulsified composition containing (A) enzyme-degraded lecithin, (B) polyglycerin fatty acid ester, (C) sucrose fatty acid ester, (D) polyvalent alcohol, and (E) water for use in alcoholic drinks or carbonated drinks, comprising:
blending the components (B), (C), (D) and (E) together; and
dissolving (A) enzyme-degraded lecithin in the blended components.
